(19) United States
(12) Patent Application Publication
(10) Pub. No.: US 2004/0119294 A1
(43) Pub. Date: Jun. 24, 2004

(54) Locking mechanism

(75) Inventor: Yong Teng Long, Singapore (SG)

Correspondence Address: NIXON PEABODY, LLP, 401 9TH STREET, NW, SUITE 900, WASINGTON, DC, 20004-2128, US

(73) Assignee: YONG TAI LOONG (PTE) LTD., Singapore (SG)

(21) Appl. No.: 10/703,485

(22) Filed: Nov. 10, 2003

(30) Foreign Application Priority Data
Dec. 20, 2002 (SG) 200207778-2

(51) Int. Cl. E05C 19/06

(52) U.S. Cl. 292/83

(57) ABSTRACT

The present invention relates to a flush latch locking mechanism for a door. In our experience, the locking member of prior art flush latches intended for use on doors 27 mm thick only travel a maximum distance of 7 mm. Therefore, there is very little tolerance for variation in the space between the door and door jamb if the door is to be held securely in a closed position. The present invention relates to a flush latch, locking mechanism including an operating lever and a retractable locking member that travels between a rearward retracted position and a forward advanced position. The locking member includes a cam surface having a raised portion which is engaged by the lever in operation so that the locking member can travel up to 13 mm when fitted to a 27 mm thick door.

### FIELD OF THE INVENTION

The present invention relates to a locking mechanism and more particularly, to a flush latch locking mechanism for a door.

### BACKGROUND OF THE INVENTION

Flush latches typically include a manually operated handle that is seated flush or substantially flush with a side of a door when in a closed position rather having a rotatable knob that extends permanently outwardly from the door.

A door fitted with a flush latch is normally opened by pivoting the handle temporarily outwardly which retracts a locking member received by an opening in a door jamb.

A disadvantage experienced by flush latches is that the mechanism which moves the locking member may be confined by the internal dimensions of the door. This ultimately limits the displacement or length traveled by the locking member during use. This difficulty is particularly evident and often results in the door being insecurely held in a closed position when the space between the door and door jamb is a significant portion of the overall distance traveled by the locking member. In other words, as the distance between the door and door jamb increases, the length of locking member received by the opening in the door jamb decreases.

In our experience, the locking member of prior art flush latches intended for use on doors 27 mm thick only travel a maximum distance of 7 mm. Therefore, there is very little tolerance for variation in the space between the door and door jamb if the door is to be held securely in a closed position.

It is therefore an object of the present invention to provide an alternative flush latch which can alleviate this problem.

### SUMMARY OF THE INVENTION

The present invention provides a flush latch locking mechanism for a door, the flush latch locking mechanism including:

a retractable locking member movable between a rearward retracted position and forward advanced position and provided with a cam surface having a forwardly raised portion; and

a pivotally mounted lever for engaging the cam surface;

wherein as the lever is pivoted, a point of engagement between the lever and said cam surface moves generally towards said raised portion, and thereby retracts the locking member towards said retracted position.

Hitherto the locking member of prior art flush latches include a flat or linear surface which is engaged by the lever.

An advantage provided by the present invention is that the raised portion of the cam surface enables the locking member to be retracted further than the locking member of prior art flush latches. Flush latches according to the present invention may therefore be used in situations where the space between the door and door jamb would otherwise be troublesome for a flush latch. Although it is possible that the cam surface of the locking member can have a concave shape, it is preferred that the cam surface be a convex shape.

It is preferred that a portion of the lever engaging the cam surface include a recess for receiving the raised portion of the cam surface when the locking member is in the forward advanced position. An advantage provided by this preferred aspect is that the cam surface can be located in a forward most position within the door when the locking member is located in the advanced position, thereby maximizing the displacement of the locking member.

It is preferred that the portion of the lever for engaging the cam surface include a concave shape for receiving the raised portion of the cam surface when the locking member is in the forward advanced position. This preferred aspect of the present invention is particularly useful when the cam surface is convex because the lever can slide smoothly over the cam surface while the locking member moves between the retracted and projected positions.

It is also preferred that the flush latch locking mechanism include a biasing means for biasing the locking member into the projected position.

The lever engaging the cam surface may be provided in the form of an L-shaped member in which one limb of the L-shape forms an operating handle for opening the flush latch, and the second limb forms an engaging arm for engaging the cam surface.

In use, the operating handle is manually pivoted outwardly and the engaging arm, connected to or extending from the operating handle, pivots backwardly and slides across the cam surface, depressing the cam surface. As the operating handle is pivoted to a lateral position across the door, an end portion of the engaging arm contacts the raised portion of the cam surface, thereby locating the locking member in the rearward retracted position.

When the operating handle is released, the biasing means causes the locking member to move forward, sliding the end portion of the engaging arm from the raised portion of the cam surface and pivoting the operating handle inwardly toward the face of the door. As the operating handle assumes a position substantially flush with the door, the engaging arm is pivoted to a position laterally across the thickness of the door so that the side face of the lever facing the cam surface is seated against the cam surface and that the locking member advances into the door jamb.

### BRIEF DESCRIPTION OF THE DRAWINGS

Two preferred embodiments of the present invention will now be described with reference to the accompanying drawings in which:

FIG. 1 is a top view of a first embodiment of a flush latch having one handle;

FIG. 2 is an illustration of the flush latch shown in FIG. 1 in which the handle is in an open position;

FIG. 3 is a top view of a second embodiment of a flush latch having two handles;

FIG. 4 is an illustration of the flush latch shown in FIG. 3 in which one handle is in an open position;

FIGS. 5 and 6 are top views of a flush latch fitted to a door in closed and open positions respectively;

FIG. 7 is an enlarged view of circle A shown in FIG. 5;

FIG. 8 is a front view of the flush latch shown in FIG. 7; and

FIG. 9 is an enlarged view of the flush latch shown in FIG. 4 with dimensions marked thereon.

### DETAILED DESCRIPTION

Save for the flush latches of the first and second embodiments being single and double handled, both embodiments are substantially identical and for convenience the same reference numerals have been used throughout the Figures to denote the same features on both embodiments.

As can be seen in the Figures, the flush latch comprises: an elongated housing 11 which is fitted to an end region 12 of a door; a reciprocating locking member 13 which can be received by an opening in a door jamb 14; a lever or handle 15 pivotally mounted to the housing; and a biasing means in the form of a helical spring 16 for biasing the locking member 13 forward.

Each handle 15 is provided in the form of an L-shaped member and includes an operating arm portion 17 that extends across a recess 18 in the housing 11 and an engaging arm 19 that extends into the housing 11.

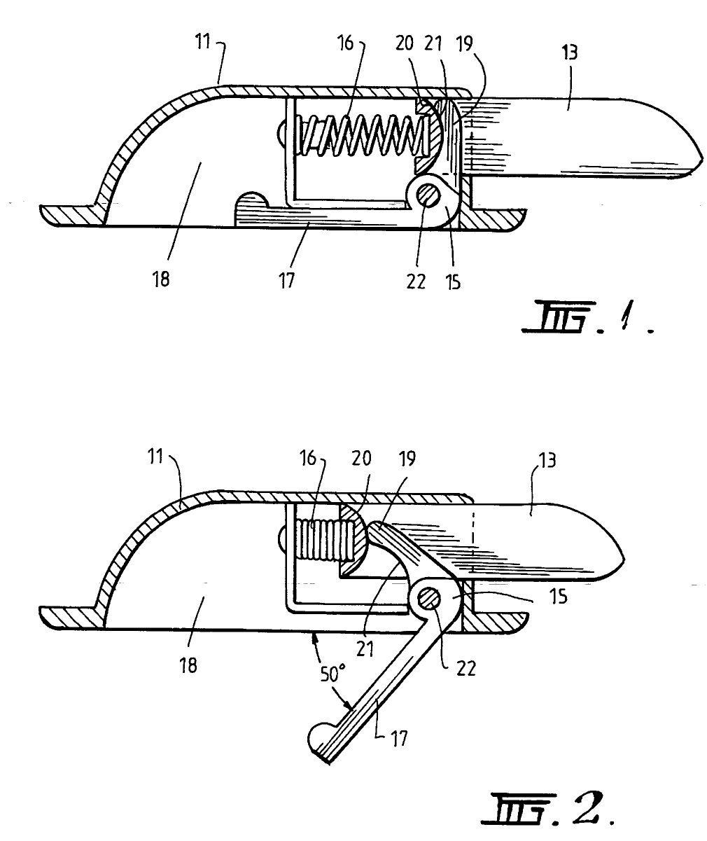

Located at a proximal end of the locking member 13 is a convex shaped cam surface 20. FIGS. 1 to 4 show the engaging arm 19 engaging the cam surface 20. In addition, each engaging arm 19 includes a portion facing the cam surface 20 that is machined or molded into a concave recess 21 for receiving the cam surface 20. The co-operating convex and concave surfaces provides several advantages, one being that the locking member 13 is able to be located in forward most advanced position when the operating arm 17 is flush with the face of the door.

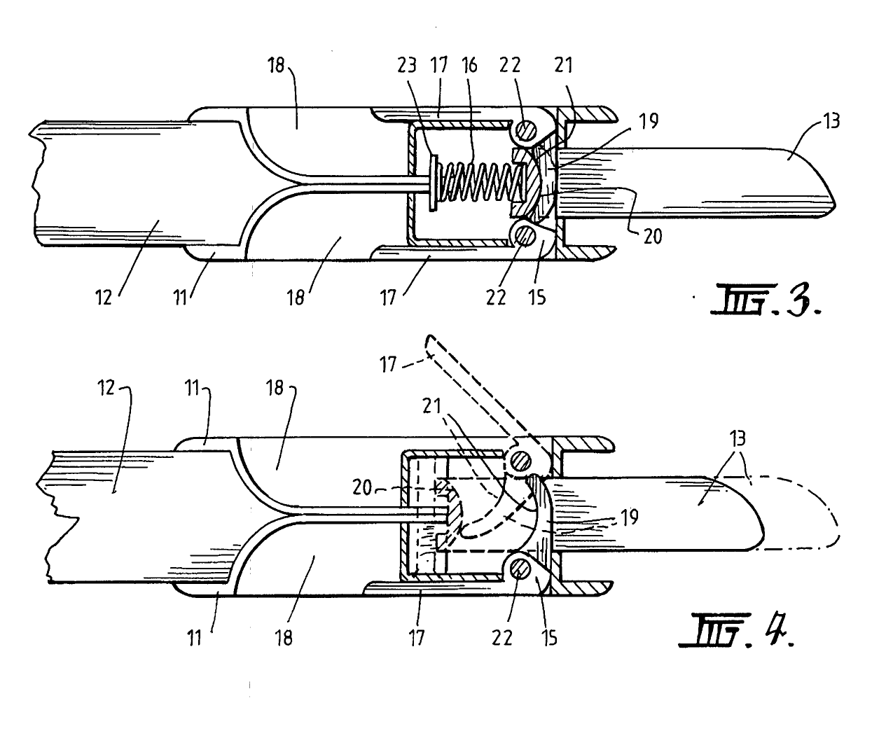

The locking member 13 moves in a reciprocating manner between the advanced position, shown in FIG. 3 (similarly in FIG. 1), and a comparatively retracted position. As shown in dotted lines in FIG. 4 (similarly in FIG. 2) the operating arm 17 is pivoted outwardly and the cam surface 20 is depressed backwardly when in the retracted position.

Specifically, in use a person moves the locking member 13 from an advanced position to a retracted position by positioning their fingers beneath the operating handle 17 in the recess 18 and pulling the operating handle 17 outwardly, as shown in FIGS. 2 and 4. Outward movement of the operating handle 17 pivots the engaging arm 19 about pivot mounting 22 which causes an end portion of the engaging arm 19 to slide over the cam surface 20, depressing the cam surface 20 and locking member 13 until the cam surface 20 is seated onto a stop plate 23 (shown in FIG. 3), thereby locating the locking member 13 in a retracted position.

As the engaging arm 19 slides over the convex cam surface 20, engagement between the cam surface 20 and engaging arm 19 changes from substantially the entire inside concave face 21 of the engaging arm 19, as shown in FIGS. 1 and 3, to only the end region of the engaging arm 19 contacting the cam surface 20, shown in FIGS. 2 and 4. In addition, as the operating handle 17 is pivoted outwardly, the engaging arm 19 moves toward a central axis of the housing 11 and moves from a lower portion of the cam surface 20 to a raised portion of the cam surface 20, thereby maximizing retraction of the locking member 13.

A person skilled in the art would appreciate that the extent to which a locking member 13 moves is largely determined by the length of the engaging arm 19 which in turn is limited by the internal dimensions of the door. In particular, according to our experience, the locking member of a flush latch fitted to a standard door 27 mm thick normally travels a length of 7 mm between the advanced and retracted positions. However, according to the preferred embodiments of the present invention, the locking member 13 for the same thickness door can travel a length of 13 mm between advanced and retracted positions, see FIG. 9.

The increased travel of the locking member 13 allows flush latches according to the preferred embodiments to be used in situations where the space between the door and door jamb 14 is too large for conventional flush latches to reliably and securely hold the door closed.

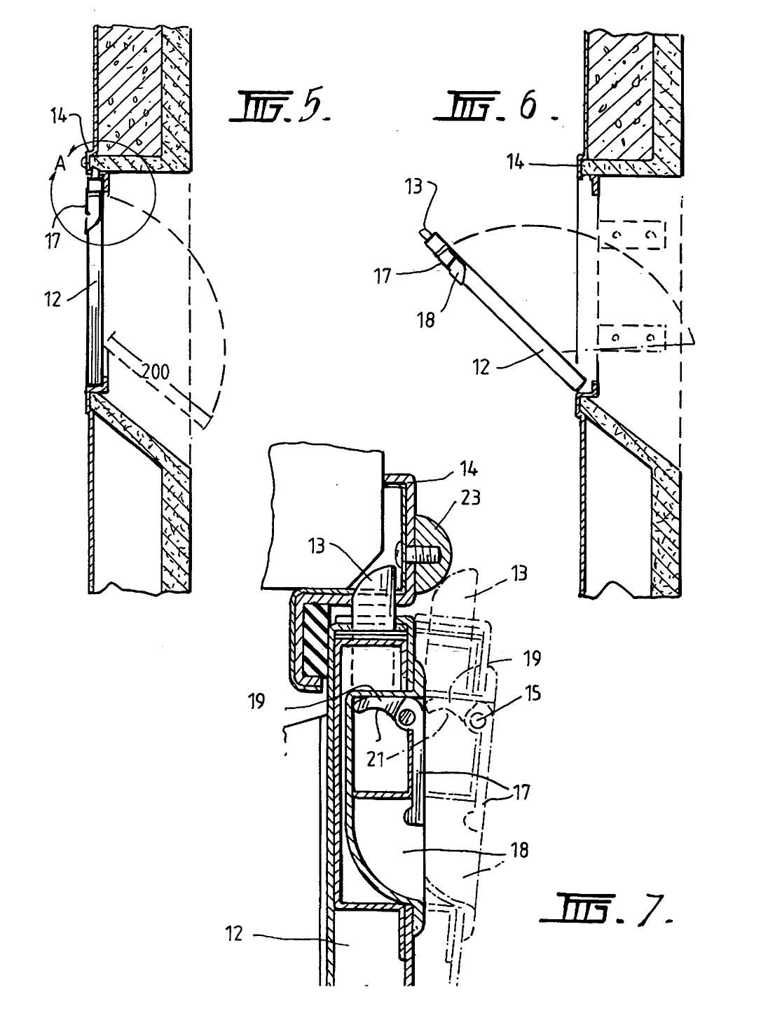

FIGS. 5 and 6 illustrate the single handled flush latch shown in FIGS. 3 and 4 fitted to a door.

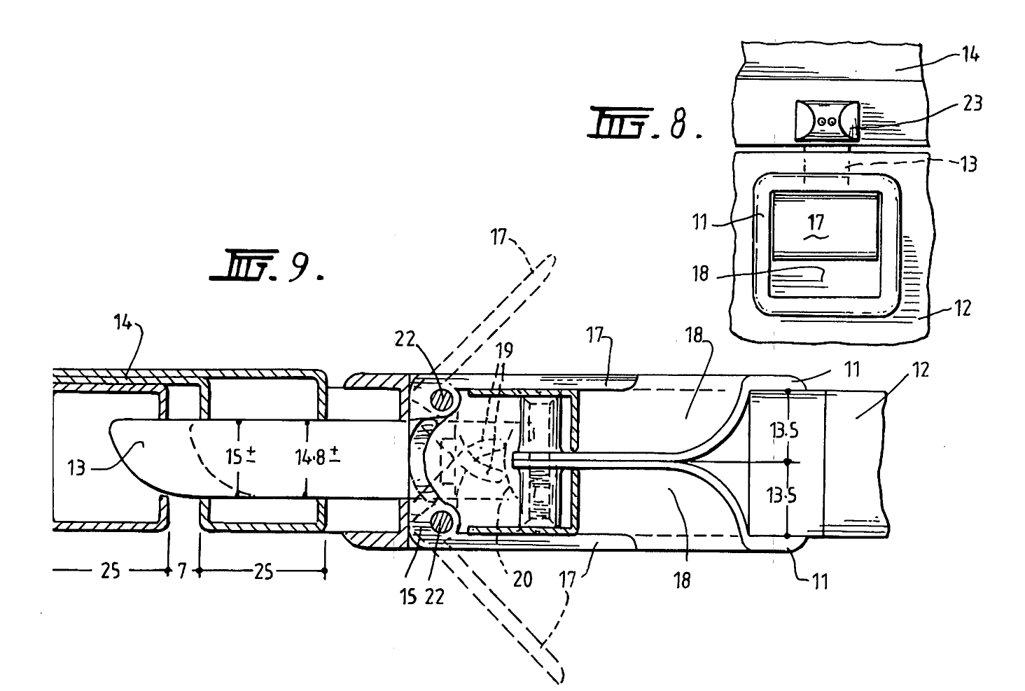

FIG. 7 shows an enlarged view of the locking member 13 spanning the space between the door and the door jamb 14 when the door is in a closed position. Fitted to the outside of the door jamb 14 is a domed striking disc 23 for engaging the curved end of the locking member 13. As the door is pushed closed, the curved end of the locking member 13 slides over the striking disc 23 and forces the locking member 13 into a rearward retracted position so that the door can be fully closed. Once closed, the spring 16 urges the locking member 13 into a forward advanced position and an opening in the door jamb receives the locking member 13 and prevents the door from swinging open.

FIG. 8 illustrates a front view of the flush latch shown in FIG. 7 with the striking disc 23 mounted to the outside of the door jamb 14.

It will be understood by a person skilled in the art of the present invention that modifications may be made to the invention without departing from the spirit and scope of the present invention.

For example, the cam surface of the locking member may have a convex shape. Similarly, the engaging portion of the lever may include a concave shape.

The claims defining the invention are as follows:

1. A flush latch locking mechanism for a door, the flush latch locking mechanism including:
a retractable locking member movable between a rearward retracted position and forward advanced position and provided with a cam surface having a forwardly raised portion; and
a pivotally mounted lever for engaging the cam surface;
wherein as the lever is pivoted, a point of engagement between the lever and said cam surface moves generally towards said raised portion, and thereby retracts the locking member towards said retracted position.

2. The flush latch according to claim 1, wherein the cam surface is a convex shape.

3. The flush latch according to claim 1 or 2, wherein a portion of the lever engaging the cam surface includes a recess which can receive the raised portion of the cam surface when the locking member is in the forward advanced position.

4. The flush latch according to claim 3, wherein said recess is provided by a concave shape.

5. The flush latch according to any one of the preceding claims further including a biasing means for biasing the locking member into the projected position.

6. The flush latch according to any one of the preceding claims fitted to a door 27 mm thick, wherein the difference between the retracted and projected position of the locking member is greater than 7 mm.

7. The flush latch according to any one of the preceding claims fitted to a door 27 mm thick, wherein the locking member travels a length ranging from 10 to 13 mm between retracted and projected positions.
